(19) United States
(12) Patent Application Publication
(10) Pub. No.: US 2008/0219885 A1
(43) Pub. Date: Sep. 11, 2008

(54) Method and Device for Collection and Transport of a Biological Sample

(75) Inventor: Tony Horstman, Queensland (AU)

Correspondence Address: STOUT, UXA, BUYAN & MULLINS LLP, 4 VENTURE, SUITE 300, IRVINE, CA, 92618, US

(73) Assignee: Oryx Holdings Pty Ltd, Red Hill, Queensland (AU)

(21) Appl. No.: 12/088,692

(22) PCT Filed: Sep. 25, 2006
(86) PCT No.: PCT/AU2006/001398

§ 371 Date: Apr. 16, 2008

(30) Foreign Application Priority Data
Sep. 29, 2005 (AU) 2005905377

(51) Int. Cl. B01L 3/00

(52) U.S. Cl. 422/61; 422/102

(57) ABSTRACT

A device for the collection and transport of biological material, the device including a container having at least two parts temporarily attached together and adapted for storage of biological collection indicia on an outbound leg of the transport and the safe transport of a biological sample on an inbound leg wherein the biological sample is rendered benign during transport and transported in one of the container parts.

### FIELD OF THE INVENTION

The present invention relates to the collection of a sample of biological material and particularly to devices to collect and transport samples in a form suitable for testing.

### BACKGROUND ART

Analysis of human or veterinary conditions by way of laboratory assay of DNA or other biochemical testing is well known. The collection of specific samples of biological material (blood, saliva, hair, semen and other secretions) by way of self-collection tools and methods is also known.

The provision of these samples to appropriate laboratory facilities by various methods of transport, including postal services, is also known.

For example, a Method of self-sampling and analysing a semen sample is described in United States Patent Application No. US2003148365, which also provides a description of two prior art methods as follows:

“Methods for transporting medical samples, such as semen, blood, bone marrow, skin tissue and the like by conventional overnight delivery/mail services have been disclosed in the prior art. For example, U.S. Pat. No. 5,983,661 to Wiesman discloses a container arrangement and method for transporting equine semen. This container allows for transporting samples of equine semen over long distance while at the same time maintaining the motility and fertility of the transported spermatozoa for at least 48 hours without the sperm being inactivated.

Devices for collection, packaging, transport and return of devices are available. Improvements in technology to extract and identify biological material, particularly Nucleic Acid fragments, has allowed precise qualitative identification of components of virtually any biological material, with suitable test chemistry.

These methods of analysis may be applied to identification of biological material, from the origin of plant matter, to identification of viral/bacterial/fungal presence in humans or animals, to identification of genetic traits in any organisms. In this instance, the primary focus remains on diagnosis of human infection, however the application should not be limited.

The sensitivity and specificity of test chemistry and extraction or amplification techniques allow specimens to be both very small and contain only trace amounts of the target material within the total sample load. Thus, non-invasive collection of material where the probability of target material being present is suitable for positive assessment is possible.

Consequently, the “patient” or user is capable of self-collecting specimens without overbearing anti-contamination measures. This enables self-collection of samples in a normal home environment, relieving the need to visit clinical facilities and involve professional healthcare workers, providing an alternative to users, offering comfort, flexibility and privacy.

One key limitation of self-collection technologies has been the provision of the specimen to the laboratory in a fit condition for testing. As the specificity and sensitivity of test chemistry has improved, however, the condition of the sample has become less important (that is, the biological material is not required in pristine “live” condition), and the need to transport material that may be considered potentially infectious is removed. The need to maintain live material, using refrigeration or other methods, is also removed. Thus, the restrictions to access of the postal system, with its associated limitations on transport of biological material, may be eased, provided the sample may be prepared appropriately.

It will be clearly understood that, if a prior art publication is referred to herein, this reference does not constitute an admission that the publication forms part of the common general knowledge in the art in Australia or in any other country.

### SUMMARY OF THE INVENTION

The present invention is directed to a device for collection and transport of a biological sample, which may at least partially overcome at least one of the abovementioned disadvantages or provide the consumer with a useful or commercial choice.

In a first form, the invention resides in a device for the collection and transport of biological material, the device including a container having at least two parts temporarily attached together and adapted for storage of biological collection indicia on an outbound leg of the transport and the safe transport of a biological sample on an inbound leg wherein the biological sample is rendered benign during transport and transported in one of the container parts.

The container having two parts may be termed a primary package when the two parts are attached together. This primary package is suitably adapted to be used in a postal system, be it local, national or international.

The primary package will typically be ordered by or provided to a user and may be dispatched to the user (once tailored or selected according to the user's specific requirements) by containing it in a casing, such as a pouch or envelope.

For the purposes of the following discussion, the following nomenclature is used:

“Kit”=the entire set of manufactured items comprising all components sent to users, including envelopes or similar
“Collection device”=the item used to physically collect the sample
“Primary package”=the two part container that the collection device arrives in and includes the return package, sample carrier and sample receiver
“Return package”=the container for the elements to be returned to the laboratory
“Sample Carrier”=the portion of the collection device to which the target biological material is collected or concentrated
“Sample Receiver”=the component within the return package into which the sample carrier is placed

Upon determination of test requirement, the user is provided, preferably using postal services, a kit adapted to the particular test. The kit will preferably contain all components for safe transport to and from the user, appropriate devices for collecting the biological sample, instructions for use and components for effective treatment of the biological sample in order to render it benign but in a form suitable for presentation to the testing laboratory and useable by the laboratory. Elements to assure the privacy, authority and sample chain of custody are also incorporated.

The kit is typically sized to suit preferred postal dimensions, such that postal volume, weight and associated costs may be reduced. For example, in Australia, suitable preferred dimensions are either a maximum of 130×240×5 mm thickness and 250 g, or 260×360×20 mm thickness and 500 g.

When dispatched by postal means, the primary package is preferably enclosed in a pouch or envelope of suitable plastics or paper material to avoid damage. The pouch or envelope is suitably pre-printed with the information appropriate to indicate paid postage and indications of contents and sender, if required. The name and address of the user will generally be added to the postal packaging by application of a printed adhesive label. In order to maintain the privacy of the user ordering and receiving the kit, the packaging may be minimally marked or identified.

The kit also typically includes a pre-printed return postal pouch or envelope of similar type, sized to fit the return package and similarly marked with identification, addressee (laboratory) and postage details. The return postal pouch or envelope may be placed in a recess or other enclosure provided in the primary package casing.

The primary package casing will suitably include top and bottom halves and a sealing means for releasably opening and resealing the container. The most preferred form of sealing means includes a perimeter seal fin and trench, typically provided with finger tabs placed to allow easy opening of the casing. The casing may be resealed by closing and pressing the top and bottom halves together. The closure should be constructed to avoid unintended opening of the case when crushed, pressurised or impacted.

The casing may be provided with openings, preferably breathable membrane or one way type openings to allow pressure and moisture balancing and further avoid inadvertent opening.

The casing will generally be manufactured from an impermeable plastic material, chosen for properties such as stability, strength, antimicrobial formulation and the like, and should not adversely affect the contents of the container during storage or transport. The casing will normally be closed in its unused state, further protecting the contents from environmental factors and contaminants.

The kit materials and component constructions are preferably be such that the kit retains a usable lifespan of several years in clean and dry storage conditions out of direct sunlight. The properties of the chemicals included in the package components are typically such that they are also not affected by temperature, humidity or atmospheric pressure in normal conditions during this period.

The kit construction should be such that damage or degradation of performance is avoided in normal foreseeable handling or storage.

Kits will usually be marked clearly with an expiry date and any storage or handling conditions, applied at the time of manufacture according to applicable regulations.

The unused kit will also preferably be sealed with tape or other tamper-evident mechanism, such as a break-away portion of the casing seal, to assure the integrity of the contents as they arrive at the user. The tamper-evident mechanism may be designed in such a way that gross attempts to open the casing or access the contents, or damage in transit, may be visually obvious. The requirement for the user to assess the integrity of the package may be noted on external instructions printed on or integral to the casing.

The kit will typically include printed or integral identification of the contents specific to the test type.

According to its functions, the kit will include sample collection devices and other components appropriate to the required test. The casing of the kit may be generic, with the contents interchangeable at the time of assembly.

The kit typically contains several key elements, namely:

1. Instructions

2. sample collection device

3. sample enclosure and treatment component

4. waste collection and disposal elements

5. return seal and user/kit identification

Upon opening, the kit may clearly display instructions for use and appropriate directions for reduction in contamination and the like. The instructions will normally be prominently displayed or accessible in a manner that remains visible throughout the use process, without the requirement for excessive handling by the user. It is intended that the instructions may be displayed on a panel attached to the lid portion of the casing, such that the lid portion of the casing remains in an open position and the user is minimally required to turn pages or otherwise handle kit materials. The instructions may be provided in a manner such that when the casing is opened, the instructions are deployed, attached to the casing and visually accessible to the user.

The instructions shall be provided in a suitable language, in text or graphic format appropriate for the task.

All sample collection devices and other components are preferably sized to fit within one or more cavities provided in one of the parts of the casing of the primary package.

The sample collection devices should be specifically designed to meet the ergonomic aspects of their intended procedure.

The design of the collection devices should preclude, by way of ergonomic shaping or other features, the incorrect taking of samples, by site or action. It is known, for example, that users may attempt to get greater value for money from a sampler by retrieving samples from multiple body sites. This potentially increases the likelihood of false negatives by swamping the sample carrier with inappropriate material.

Kits are preferably provided to the user in a sterile condition, such that contamination may be minimised or reasonably identified. The kit casing shall be suitably constructed and sealed to enable maintenance of the internal sterile conditions during storage and transport, and promote non-contamination during use.

In general, the collection devices shall include a “sample carrier” in various forms, all of which typically are or include a removable portion of minimal size which carries the target material, for return to the laboratory. As described above, only very small amounts of target material are generally required for analysis, and the laboratory has no use for the entire collection device. In order to reduce the volume of waste material returned to the laboratory (and thus postal bulk and cost), the target material is preferably concentrated onto only the sample carrier for return. Each of the preferred sample collection types described shortly employs a form of sample carrier configured in this manner.

As the collection devices generally pose negligible biological safety risk, and materials are selected to be disposable and benign, all components unnecessary for return of the sample carrier itself may be discarded by the user.

In each instance, the sample carrier should be sized and configured such that it may be easily handled and manipulated without contact with the collected material, thus avoiding contamination, and should be removable from the body of the collector by means of a handling portion configured such that the user is not subject to contact with the sample area itself, which may be objectionable. This may entail an elongate tail or flap integral with the material, a string or other non-integral “handle” means. A specific handling area may be printed, marked or otherwise indicated on the carrier component.

The sample carrier should carry the target material in a manner that it may be released into fluid upon immersion and agitation of the sample carrier. As such, the sample carrier will not require inversion (if formed into a bag configuration) nor create traps or corners where particles may become trapped and thus lost to the test.

Following collection of the sample and isolation of the sample carrier, the sample carrier is then preferably treated to render the material benign to enable postal carriage. Postal acceptance rules, particularly in the absence of special-purpose packaging, commonly require the sample to be non-viable and non-infectious. This “stabilisation” may be achieved by physical or chemical destruction or bonding of the sample material or by removal of any medium which may sustain or allow dispersal of biological material. In this way, nucleic acid material may be denatured or cleaved and cellular or other molecular material may be chemically altered and/or the sample may be dried or deprived of a suitable growth media. The degree of denaturing and molecular alteration dictates the nature of remnant material that may be recognised by the subsequent analysis chemistry.

The shorter the remnant nucleic acid fragments, or the more random/severe the chemical alteration, the more specific the test chemistry must be (greater “specificity”), and the less likelihood of a positive match or reaction and successful test. The probability of the test providing a correct positive result is the “sensitivity” of the test. Thus, high specificity and sensitivity is the goal of the test chemistry.

With the objective of maximising sensitivity and specificity in testing, the amount of molecular alteration or denaturing of the sample should be minimised, thus, the chemical action of the sample receiver must be relatively mild. The sample receiver will preferably also remove moisture from the sample, such that no free fluid is present in the package which may present a sustaining medium.

The sample receiver may preferably incorporate two features, namely desiccation and chemical treatment of the sample.

Desiccation may be largely achieved by use of a highly absorbent substrate, such as thick blotting paper. Desiccation may also be assisted by inclusion in the kit of an absorbent material such as silica gel.

The chemical treatment may be achieved by addition to, or impregnation of the substrate with a substance activated when in contact with the sample. One embodiment is the addition of a crystalline salt, which may be impregnated into the substrate by wetting in solution followed by drying. When the sample carrier is placed upon the sample receiver, the moist sample typically dissolves some of the salt, creating an appropriate chemical environment to stabilise the sample. Being crystalline, the salt also generally assists in dispersal of moisture and desiccation of the sample. For example, a salt which creates a mildly alkaline solution known to disrupt biological molecules, and which is readily available and suitable for impregnation into an absorbent substrate is Sodium Hydroxide (Caustic Soda or NaOH). A gentler and preferred solution is Sodium Chloride (NaCl), with the extent of disruption controlled by the volume of impregnated salt and the subsequent concentration of the solution surrounding the wet sample.

The continued contact with the sample receiver chemicals, particularly when dry, will typically prevent any recombination or sustained viability of the biological material. The sample receiver is suitably required to completely enclose the sample carrier, and provide maximum contact for the chemical and drying action.

The sample receiver shall be suitably sized to enclose the various sample carriers, and shall remain in a predominantly flat shape when encapsulating the carrier.

The sample receiver may be a folded sleeve of absorbent material, for example blotting paper. The sleeve may simply be a pair of leaves with a single fold line, or a more complex envelope structure to retain the sample carrier. The sample receiver may be separable from the kit casing, or retained by the structure.

Dependent on the type of sample associated with the kit, the sample receiver or other element of the return package may include a deodorizing agent to mask or remove any odour that may emanate from the sample.

The nature of the chemicals may require that the sample receiver is configured to avoid direct user contact with the impregnated portion, by means of a laminated plastic construction or non-absorbent backing.

The sample receiver may also be configured to reduce the handling required to enclose the sample carrier. The sample receiver may include a folded corner or other shaped section to allow easy opening of the folded sleeve. The sleeve may be automatically opened by the opening of the kit casing, such that the receiving surface is presented immediately, with no handling required.

The sample carrier may be placed within the receiver in any orientation, however, in order to maximise the treatment action, the carrier may be placed such that it is substantially spread flat onto the receiver surface. It is not intended that the carrier is manipulated by the user to maintain a flat shape, rather adopting a natural position suitable for enclosure. A printed outline indicating position or orientation may be placed on the receiver surface to act as a placement guide to the user.

To achieve a spread position, the sample carrier membrane (which may be inherently prone to crumpling) may be reinforced at its perimeter or other areas to maintain a substantially flat or extended structure when removed from the collection device body.

To further reduce the risk of contamination, the sample receiver may be marked with alignment marks indicating the position of the sample carrier with the elongated tail or handling portion external to the receiver sleeve, such that potentially contaminated handling portions are physically separated from the target material.

Depending on the nature of the sample (e.g. a hair sample), the chemical treatment of the material may not be required, or may be very mild. For particularly robust samples, treatment may be customised at a more aggressive level. The chemical action may be modified by concentration or composition to achieve the desired level of sample stabilisation.

Certain kits not requiring sample treatment may exclude the impregnated sample receiver in favour of a non-impregnated sleeve. In order to simplify the manufacturing or assembly process, it is likely that all kits will retain the full complement of components, but with variants of materials or chemical applications.

Upon closure of the casing, the sample receiver sleeve is slightly compressed by the walls of the casing, thus retaining the sample carrier and ensuring maximum contact of the sample carrier to the receiver chemicals.

The material and surface treatment of the sample receiver is selected such that minimal target sample material is removed from the sample carrier upon removal of the sample carrier at the laboratory. The sample carrier is preferably removed from the receiver either by simply tipping out, or removing with tweezers.

The user is preferably required to identify themselves and provide a signature which indicates agreement to the terms and conditions of the testing process (provided with the kit, or in external literature); authority to use the sample provided; and verification that the sample is indeed provided by them, according to the instructions provided. This signature may be applied to a panel affixed to the kit, preferably on an outer side of the casing. The signature panel should be affixed to the returnable portion of the kit and may be incorporated into the tamper-evident return seal, whereby the application of the seal is also verified by the signature.

The signature may be accompanied by a date, from which the natural degradation of the specimen over time and the likelihood of a successful test may be judged.

The return seal may comprise a self-adhesive label, which, with the backing layer removed, may be affixed over the casing closure and permanently adhered to the opposing side. The label adhesion may be sufficiently strong to destroy the label on attempted opening, or the label may incorporate weakened or perforated sections to enable rapid verification of casing integrity. The correct positioning of the label may be indicated on the casing, such that incomplete closure may be rectified by the user prior to attachment. Identification indicia may be provided on the return seal.

For the purposes of verifying the identity of the user when collecting test results, a unique identifier matched to the kit may be retained by the user. This identifier may be printed on the rear backing layer of the adhesive tamper label or another removable portion of the labelling. Should results be collected by phone or online, the user may quote this identifier to verify their identity.

The user signature label may be positioned to enable scanning, complete removal or other recording of the application of the signature by the laboratory, as this label constitutes a legal document and record of chain of custody. To protect user privacy, the identification and authority label may be removable prior to provision of the kit to the testing laboratory. Thus, personal identification is removed, and the kit is thereafter identified by a unique numerical or other code.

To reduce the volume of material returned to the laboratory, the primary package casing or container is typically divided into two segments or parts which are designated for enclosure of the sample, and for the collection devices. The parts of the casing are attached to one another until the user forcibly separates the two parts. The segment of the kit casing which contained the collection device may be attached to the other by means of a thin neck, line of weakness or other means, such that it may be broken away or otherwise removed for return of the sample. The integrity of the perimeter seal should not be affected by this broken portion.

The removed portion of the casing may be used to enclose the used collection device, for discrete disposal by the user.

The return package will typically provide the same level of protection to the contents as the primary package.

Opening of the casing at the laboratory is preferably easy, quickly accomplished and safe, in terms of operator health and contamination/damage to the sample. The tamper evident labels or mechanisms should allow for rapid assessment of integrity, followed by simple removal or deactivation for kit opening. The position of tamper-evident elements and the shaping of the casing should enable safe opening of the casing by lab staff, by for example, providing a guide slot or similar in which to run a sharp knife to slit the seal label.

For identification of the sample through the laboratory analysis, a series of pre-prepared identification labels or markers may be incorporated into the kit, such that as the sample is removed from the carrier, the receptacles or testing vials may be provided with matching labels taken directly from the test kit, to minimise mistakes in identification of the sample. The tamper seal may incorporate a suitable number of removable labels incorporating barcodes or other identifiers readable by the laboratory. The number of labels provided will match the common process of laboratory test steps.

An alternative method of sample identification may be the use of single or multiple Radio Frequency Identification (RFID) devices, placed on the sample carrier or other component of the kit. Due to the small size and robustness of these chips, and their unique identification characteristics, the chip may be suitably protected and incorporated into the volume of test fluid and, as such, follow the sample to the conclusion of the test without the need for further labelling.

An advantage of the use of RFID identity tags is that a database of test progress and completion may be automatically generated and the risk of human-error in mislabeling or incorrect entry are reduced.

The sample carrier is also typically designed at minimal size such that separation of the target material in the laboratory uses minimal fluid volume. Commonly the sample carrier is placed in a container of fluid suitable to remove biological material from the substrate and agitated to assist removal. The smallest possible sample carrier requires a smaller fluid volume and thus less wastage and cost for the laboratory.

The preferred collection devices used according to the present invention preferably fall into the following categories:
1. Blood sampling—Requiring skin-prick or other sharps penetration
2. Fluid sampling—Includes any free flowing fluid of low viscosity, from which material is filtered, particularly urine
3. Internal (wet) swab—Includes cervico/vaginal swab or tampon
4. External (dry) swab—Includes abrasive pads or wettable sponge wipe
5. Adhesive panel—For hair or other large dry fragments
6. Probe—For faecal sample or other semi-solid

### Category 1—Blood Sampling Devices:

A lancet device or other skin-penetrating mechanism is required to draw the required blood sample
The drop/s of blood is/are placed in a position marked on an absorbent substrate. This sample carrier may be placed within the sample receiver.
Sharps selected for this purpose shall typically be proprietary items, selected for appropriate performance and fit to the kit.
Any sharps device in a used condition must be stored and disposed of in a regulated manner, preferably stored in an approved sharps container or other protective mechanism and incinerated as medical waste. Thus, the user commonly cannot dispose of the used lancet.
The lancet device may therefore be returned to the laboratory with the return package for correct disposal, according to the enclosed instructions.
The kit casing typically includes provision of a recess or position within the return package for placement of the used sharp
The sharp should be retained by the casing or otherwise removable from the casing for disposal by the laboratory in a safe manner. A recess incorporated in the casing with intruding “fingers” may be sufficient to retain the lancet device.
The kit casing or the sharps device itself shall meet the requirements of standards for the transport of used sharps, by way of puncture resistance and exposure of the sharp. Many devices are commercially available which incorporate integral safety features suitable for this application.

### Category 2—Fluid Sampling Device:

The most common application of this category is sampling of urine, although a similar device may be adapted for sampling of toilet water (fluid in contact and carrying faecal matter) or other fluid.
Fluid sampling may be undertaken in three ways:
   Direct absorption of fluid onto an absorbent panel; or
   Gravity-assisted coarse filtration through a membrane; or
   Pressure assisted filtration through a fine membrane.
A direct absorption fluid collector may simply carry an exposed end for plunging into a fluid volume, shaped to suit a particular application and suitably absorbent or textured to retain a minimal sample volume.
A direct absorption collector may be attached to the non-return portion of the kit casing, such that kit casing (being supplied sterile) itself may be used as a cup to catch a small volume of urine with the user holding the lid portion and allowing the base portion to fill sufficiently to wet the absorbent panel removeably affixed therein.
A gravity assisted fluid collection device usually incorporates a cup element sized to gather a suitable volume of fluid (approximately 20 to 30 mL)
The gravity assisted fluid collector suitably contains a highly absorbent material comprised of either compacted fibres relying on capillary absorption, or other chemical means.
The absorbent material is preferably separated from the collection volume by a hydrophilic membrane (sample carrier) with pore size suitable to act as a coarse filter for the target particles as fluid is drawn through.
The absorbent material is in contact with the membrane and pore size is selected to ensure penetration and drawing-through of the fluid is rapid and consistent.
The surface of the membrane may be textured or otherwise treated to promote adherence of target particles to the membrane.
The filter membrane/sample carrier is typically attached removeably to the collection device housing, such that it may be removed from the housing following absorption of the target fluid, loaded with the collected material.
The collection device may be packaged in a flat form, with fold-out or otherwise expandable members, to allow enclosure within the restricted volume of the kit.
The absorbent material may be allowed to expand during its action, and expansion members may be provided in the collector housing to accommodate or control this.
A pressure assisted fluid collection device usually incorporates a vessel of suitable volume (20 to 30 mL), provided with an opening to facilitate urination into the vessel. The opening may preferably be in the form of a cap or end with funnel-shaped aperture, affixed to the vessel which is preferably configured to be collapsible from a position of greater volume (filled with fluid) to a position of lesser volume (fluid expelled).
The pressure assisted fluid collection vessel will typically be provided in the collapsed (minimal volume) position such that it occupies minimal kit space.
A secondary cap carrying a filter element is provided to be sealably affixed to the aperture of the vessel, such that fluid may be expelled from the vessel upon compression by finger pressure, via the filter element.
Filter pore size may typically be in the range 0.5 to 5 micron
The vessel and cap/s are preferably shaped or incorporate overhangs or lips to shield the user from contact with fluid and to reduce sample contamination.
The filter element is removeably affixed by way of a thermal weld, mechanical or adhesive bond, such that it will remain in position and leak-free under finger pressure collapsing the collection vessel, but which may be easily peeled away or released by means of an elongate tail portion without risking contamination by contact with other items.
In each collection instance, the sample collection panel or membrane is removed and presented in a substantially flat format suitable for the next step of stabilisation and transport.

### Category 3—Internal (Wet) Swab Sampling Devices:

This category of devices are provided in the form of padded or absorbent-ended swabs. The collectors may be used in any instance where a target material is removed by wiping or absorbing from a surface. This includes buccal cells (inner cheek), vaginal swabs, rectal swabs, external swabs etc.
The sample collection device may incorporate an absorbent substrate enclosed by a removable membrane sample carrier, or may incorporate a non-absorbent padded substrate enclosed by the sample carrier. In either case, the target material is drawn into or wiped onto the sample carrier, with the resilient substrate providing sufficient contact to the target surface that the sample collection is maximised.
The action of collecting the target material may be a process of fluid or moisture absorption, leaving material on the membrane surface, as described in the fluid sampler above, or it may be simply sweeping or gently abrading particles from the surface.
Again, the sample carrier material should be sufficiently retentive to the target material to enable maximum collection.
The sample collection device may include a rigid substrate surrounded or covered by the sample carrier, with no padding or absorbent substrate. The device body may be shaped to suit the contours of the collection site.
The sample collection device preferably incorporates an elongated handle, to enable control and orientation of the device. The handle may be shaped in any way to improve the ability to hold and control the device in a self-collection scenario.
The sample carrier may be attached removeably to the collection device body by means of adhesive material, mechanical connection or other means. A preferred embodiment incorporates attachment by means of slits in the body of the device, into which a small portion of the carrier material is pressed, providing a cheap and effective assembly solution with minimal risk of complication at the point of removal.
The sample carrier also suitably incorporates a tail or handling portion as described above, such that the portion of the carrier that must be touched by the user is remote from the sampling area.
For use in cervico-vaginal cell collection, the device may incorporate an expanding absorbent mass, similar to a tampon that may be inserted into the vagina for a longer period, such that the increase in size and additional absorption may increase the sample yield from all areas of the vagina. This mass may be sheathed in a removable sample carrier, to reduce transit and laboratory volume.
The sample carrier may also be configured integrally to the form of a finger sheath, thus collecting target material on the sheath surface with digital application. The formation of the sheath and the use of longitudinal stiffening elements may avoid the tendency for the sheath to invert and trap target material. The inner layers of the sheath in contact with the user may be impermeable to avoid contact with the target material. The entire sheath may then form the sample carrier, to be processed in its entirety.
Alternately, a swab which requires expansion to fill or extend into a cavity may employ mechanical or other means to maximise the sample collection area in contact with the target surface.

### Category 4—External Swab Sampling Devices:

This device category differs from internal (wet) swab devices in that these are adapted to remove dry material from a dry surface.
The sample carrier may be adapted to carry an external surface that is textured, abrasive, adhesive or moistened at the time of application to remove dry material from a surface and capture it on the carrier surface.
The device may incorporate a substrate that is deformable, padded or otherwise conforming to the target surface, to enable maximal sample carrier contact with the surface.
The device may be used in conjunction with the adhesive panel collection devices described below.

### Category 5—Adhesive Panel/Dry Material Collection Devices:

Incorporates an adhesive panel suitable for the collection of skin cells or free dry material, by placing the panel over the target surface and applying a compressive force or by simply placing the target material onto the adhesive panel.
The adhesive panel may be provided with a repositionable cover to maintain adhesive properties prior to use.
The adhesive panel may be used as a location panel for large scale free samples, such as hair strands.
Collection of dry biological material may require the wetting of the sample receiver in order to activate the chemicals which stabilise the material. For example, fungal fragments or spores may survive contact with sample receiver chemicals in the dry state, but may be unlikely to survive contact with the more active solution if a drop of water is added to the receiver.
The device may include the ability of the adhesive used in the panel construction to be water soluble, such that the adhesive and the material captured by it may be washed into suspension for concentration and analysis.
The adhesive panel device may be used in conjunction with or without the sample receiver or treatment action.

### Category 6—Probe Devices—Consider the Following:

A probe device may incorporate a sponge, scoop, punch or blade “head” to dislodge and capture particles of larger semi-solid samples.
A probe device may also incorporate an extended handling body attached to the head
The head may be adapted to be squeezed, retracted or otherwise eject the material collected without the need for the user to contact the sample directly. An embodiment may include a punch tube with a mating internal rod slidably engaged within such that forward motion of the inner rod will eject material collected in the tube end by the action of punching the tube into a sample.
The target material may be collected onto a sample carrier sheath or cover, equipped with an elongated handling area as described above for remote removal of the carrier from the collector body and placement within the sample receiver.
The collected material may alternately be deposited directly into the sample receiver.

In a second form, wherein individual transport and thus the robust casing of the kit is not required, such as may be the case when in use at a collection centre or supervised collections, the sample collection device itself may incorporate elements of the sample carrier, receiver and labelling requirements into one component.

In this instance, the collection devices, including, for example, the swab sticks or the collapsible urine vessels are provided to the user without the kit, and the sample carriers, when collections are complete, are transported to the laboratory in bulk.

In this form, the sample carrier may allow for additional space on the handling “tail” portion of the carrier to enable recording of user identification, plus a fold-over or other enclosing portion into which the sample collection end of the carrier may be placed.

In this way, the bulk and waste materials associated with testing of a number of users is reduced, and patient details securely accompany the sample to a testing facility.

The sample collection end of the integrated carrier performs the filtering, swabbing or other function as described above, as does the enclosing and stabilising segment of the carrier. By linking these elements together and allowing written information to be applied, the versatility of the system is enhanced.

The sample receiver portion of the integrated carrier may require non-absorbent backing or a similar barrier to handling, or may carry a removable cover to maintain cleanliness until the sample carrier portion is ready to be received. In this instance, the enclosure of the sample carrier may be undertaken by a practitioner rather than by the user themselves.

### BRIEF DESCRIPTION OF THE DRAWINGS

Various embodiments of the invention will be described with reference to the following drawings, in which:

FIG. 1 is a perspective view of a primary postal package according to a preferred embodiment of the invention.

FIG. 2 is a top view of the primary postal package illustrated in FIG. 1.

FIG. 3 is an underside view of the primary postal package illustrated in FIG. 1.

FIG. 4 is a perspective view of the primary postal package illustrated in FIG. 1 when open.

FIG. 5 is a perspective view of the primary postal package illustrated in FIG. 1 receiving a sample.

FIG. 6 is a perspective view of the postal package illustrated in FIG. 1 separated to form the return package.

FIG. 7 is a perspective view of a blood sampling collection device according to a preferred embodiment of the present invention.

FIG. 8 is a perspective view of a direct absorption fluid collection device according to a preferred embodiment of the present invention.

FIG. 9 is a perspective view of a gravity assisted fluid collection device according to a preferred embodiment of the present invention.

FIG. 10 is a perspective view of a pressure assisted fluid collection device according to a preferred embodiment of the present invention.

FIG. 11 is a perspective view of a pressure assisted fluid collection device in the process of compression and fluid filtering.

FIG. 12 is a perspective of a cervico-vaginal sampling collection device according to a preferred embodiment of the present invention, including wet swab and tampon-type device.

FIG. 13 is a perspective view of a dry swab collection device according to a preferred embodiment of the present invention.

FIG. 14 is a perspective view of an adhesive panel collection device according to a preferred embodiment of the present invention.

FIG. 15 is a perspective view of a probe punch collection device according to a preferred embodiment of the present invention, including a detail cutaway view.

FIG. 16 is a perspective view of an integrated sample carrier device according to an alternate embodiment, showing a generic sample carrier and integrated receiver enclosure.

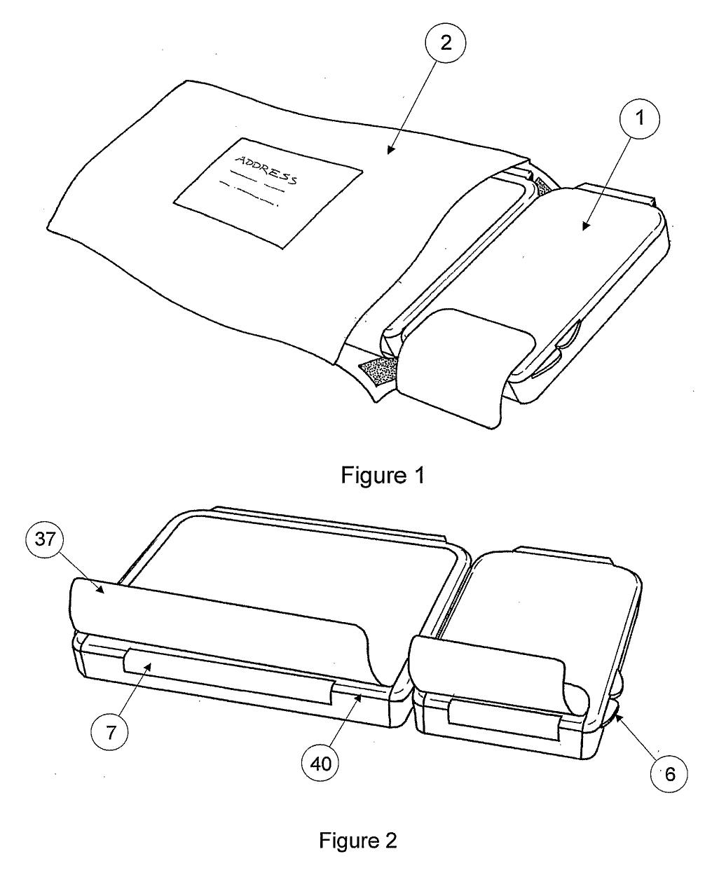

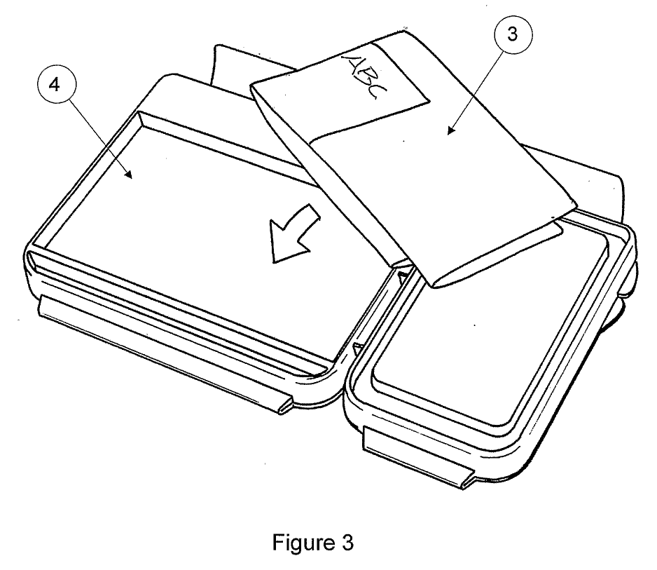

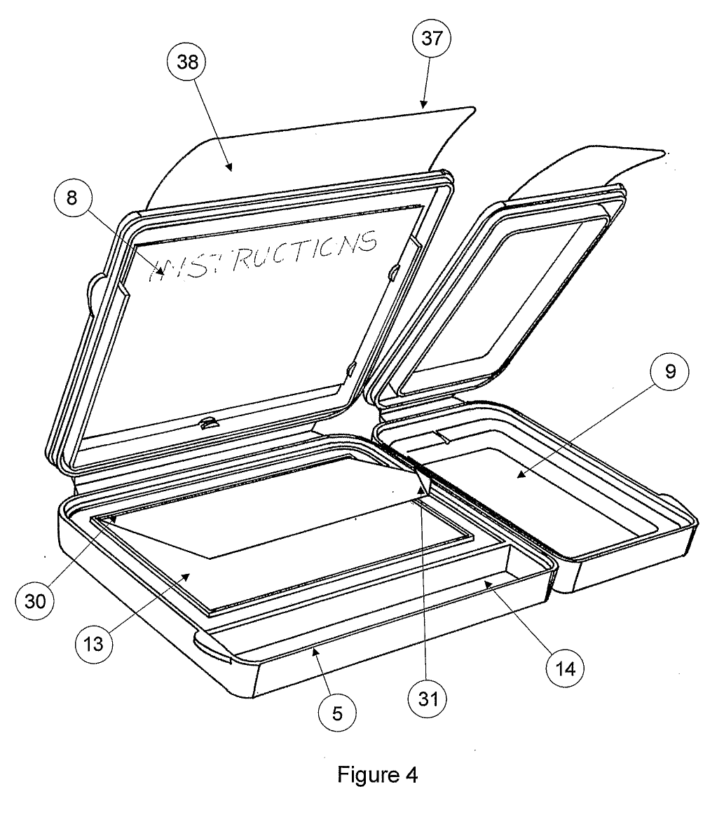

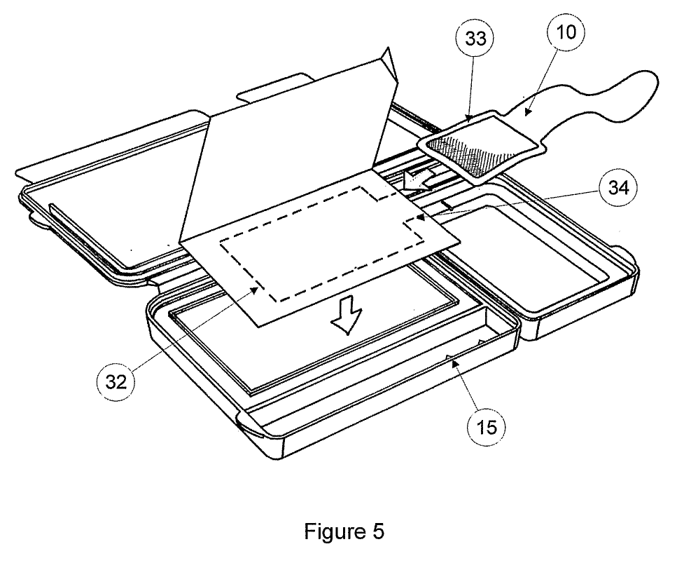

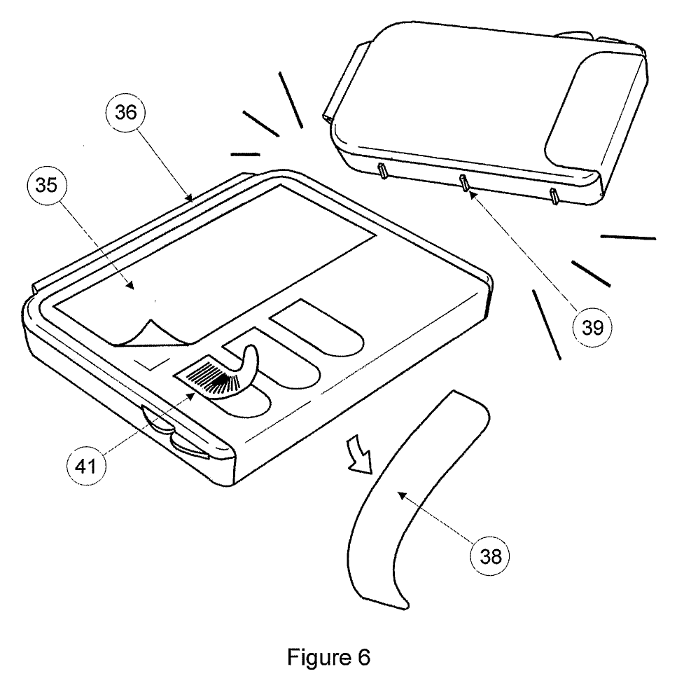

### DETAILED DESCRIPTION OF THE PREFERRED EMBODIMENT

According to a preferred embodiment, various forms of a device adapted for the delivery of a sample collection kit, collection of a sample and return of the sample to an analysis facility are provided.

For the purposes of the following discussion, the nomenclature used is as above.

Upon determination of test requirement, the user is provided, preferably via postal services, a kit adapted to the particular test.

The kit contains all components for safe transport to and from the user, appropriate devices for collecting the sample, instructions for use and components for effective treatment of the specimen for presentation to the testing laboratory.

The kit is sized to suit preferred postal dimensions, such that postal volume, weight and associated costs may be reduced. In Australia, suitable preferred dimensions are either a maximum of 130×240×5 mm thickness and 250 g, or 260×360×20 mm thickness and 500 g.

The primary package (1) is enclosed in a pouch or envelope (2) of suitable plastics or paper material to avoid damage, pre-printed with the information appropriate to indicate paid postage and indications of contents and sender, if required. The name and address of the user will be added to the postal packaging by application of a printed adhesive label. In the interests of privacy, the packaging may be minimally marked or identified.

The kit includes a pre-printed return postal package (3) of similar type, sized to fit the return package and similarly marked with identification, addressee (laboratory) and postage details. The primary package may be placed in a recess or other enclosure (4) incorporated into the primary package casing.

The primary package casing includes a means for releasably opening and resealing the container. A perimeter fin and trench seal (5) may be used, with finger tabs (6) placed to allow easy opening of the case. The casing may be resealed by closing and pressing the top and bottom halves together. The closure seal should be constructed to avoid unintended opening of the case when crushed, pressurised or impacted.

The casing may be breached at some point to avoid internal pressure imbalance that may contribute to inadvertent opening, and to enable evaporative escape of any residual internal moisture.

The casing shall be constructed from an impermeable plastic material which, by its properties, shall not adversely affect the contents. The casing shall be closed in its unused state, further protecting the contents from environmental factors and contaminants.

The kit materials and component constructions should be such that the kit retains a usable lifespan of several years in clean and dry storage conditions out of direct sunlight. The properties of the chemicals included in the package components shall also not be affected by temperature, humidity or pressure in normal conditions during this period.

The kit construction should be such that damage or degradation of performance is avoided in normal foreseeable handling or storage.

Kits shall be marked clearly with an expiry date and any storage or handling conditions, applied at the time of manufacture.

The unused kit shall be sealed with tape or other tamper-evident mechanism (7), such as a break-away portion of the casing seal, to ensure the integrity of the contents as they arrive at the user. The tamper-evident mechanism shall be designed in such a way that gross attempts to open the casing or access the contents, or damage in transit, may be visually obvious. The requirement for the user to assess the integrity of the package may be noted on external instructions printed on or integral to the casing.

The kit will include printed or integral identification of the contents specific to the test type.

The kit will include sample collection devices and other components appropriate to the required test. The casing of the kit may be generic, with the contents interchangeable at the time of assembly.

The kit contains several key elements, namely:

6. Instructions

7. sample collection device

8. sample enclosure and treatment component

9. waste collection and disposal elements

10. return seal and user/kit identification means

Upon opening, the kit shall clearly display instructions for use and appropriate directions for reduction in contamination or the like (8). The instructions shall be prominently displayed in a manner that remains visible throughout the use process, without the requirement for excessive contact with the kit interior by the user.

Instructions shall be provided in a suitable language, in text or graphic format appropriate for the task.

All sample collection devices and other components will be sized to fit within the cavities provided in the casing (9).

The sample collection devices should be specifically designed to meet the ergonomic aspects of their intended procedure.

The design of the collection devices should preclude, by way of ergonomic shaping or other features, the incorrect taking of samples, by site or action.

In general, the collection devices shall include a “sample carrier” (10) in various forms—a removable portion of minimal size which carries the target material, for return to the laboratory. As described, only very small amounts of target material are required for analysis, and the laboratory typically has no use for the entire collection device. In order to reduce the volume of waste material returned to the laboratory (and thus postal bulk and cost), the target material is concentrated onto only the sample carrier for return. Each of the specific sample collection types described in detail below employ a form of sample carrier configured in this manner.

As the collection devices pose negligible biological safety risk, and materials are selected to be disposable and benign, all components unnecessary for return of the sample carrier itself may be discarded by the user.

The sample carrier should be sized and configured such that it may be easily handled and manipulated without contact with the collected material, thus avoiding contamination, and should be removable from the body of the collector by means of a handling portion (11) configured such that the user is not subject to contact with the sample area itself which may be objectionable. This may entail an elongate tail or flap integral with the material, a string or other non-integral “handle” means. A specific handling area may be printed, marked or otherwise indicated on the carrier component.

The sample carrier should carry the target material in a manner that it may be released from the sample carrier into a fluid upon immersion and agitation.

As such, the sample carrier cannot be turned inside out (if formed into a bag configuration) nor create traps or corners where particles may become trapped and thus lost to the test.

The collection devices fall into the following categories:

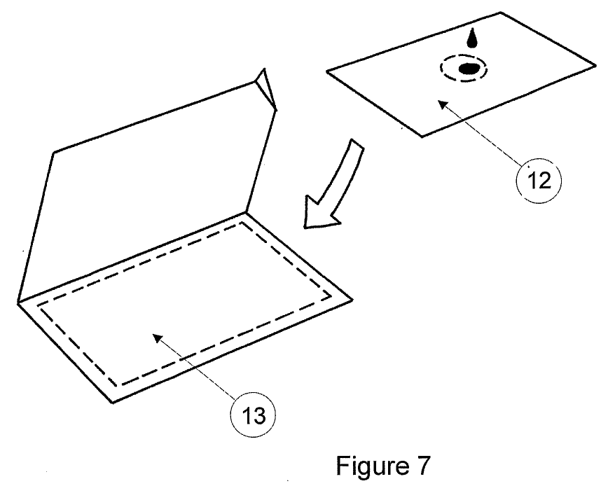

7. Blood sampling (FIG. 7)
Requiring skin-prick or other sharps penetration

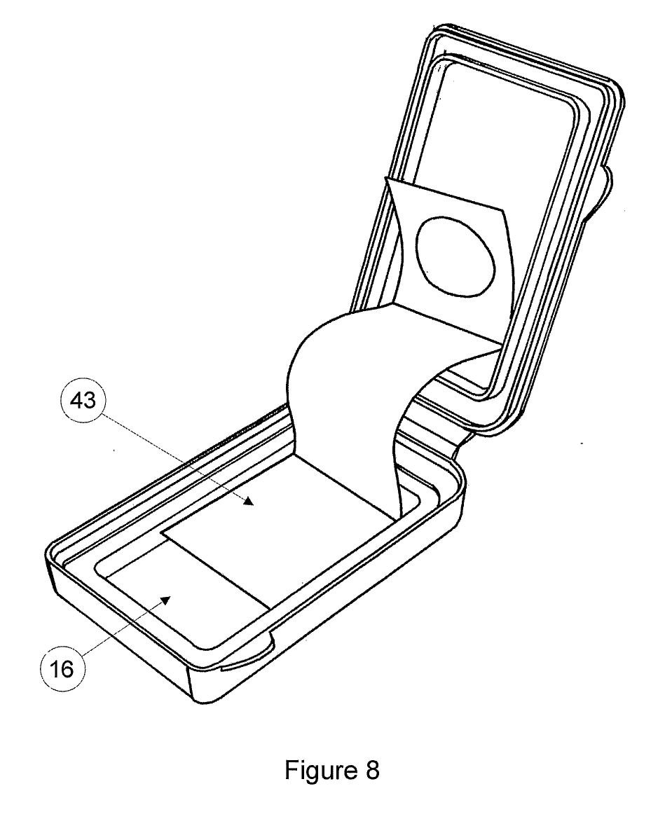

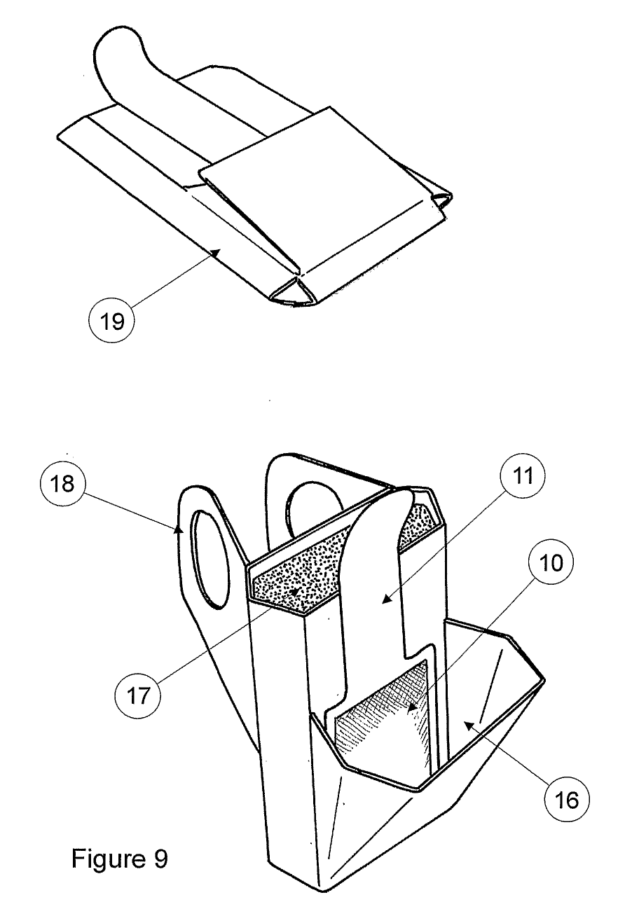

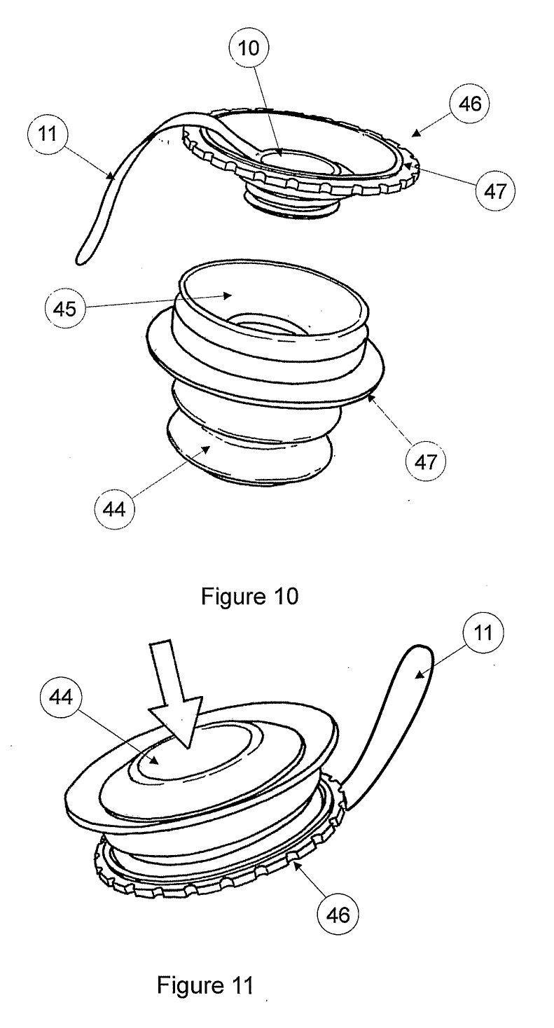

8. Fluid sampling (FIGS. 8, 9, 10 and 11)
Includes any free flowing fluid of low viscosity, from which material is filtered

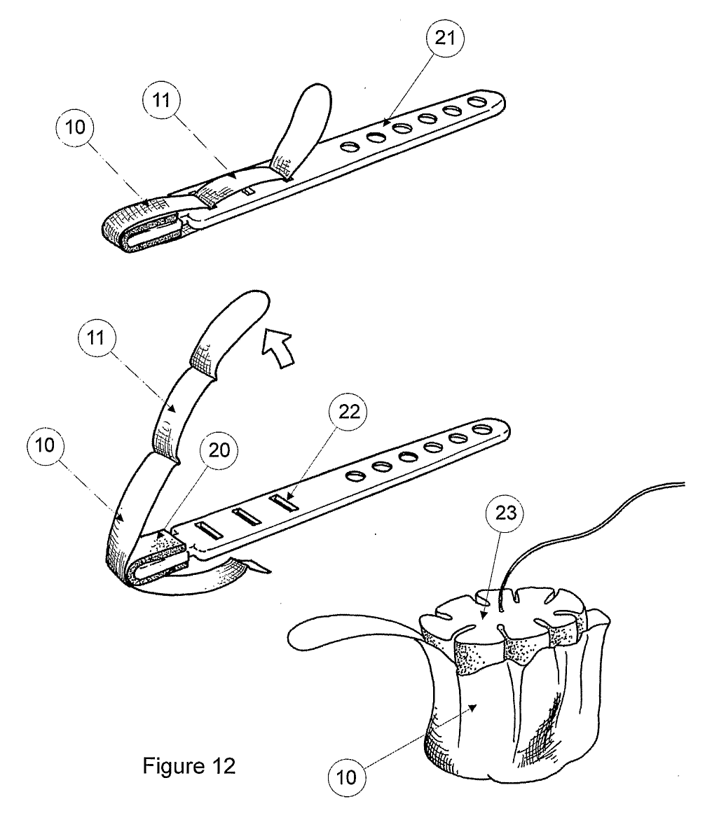

9. Internal (wet) swab (FIG. 12)
Includes cervico/vaginal swab or tampon

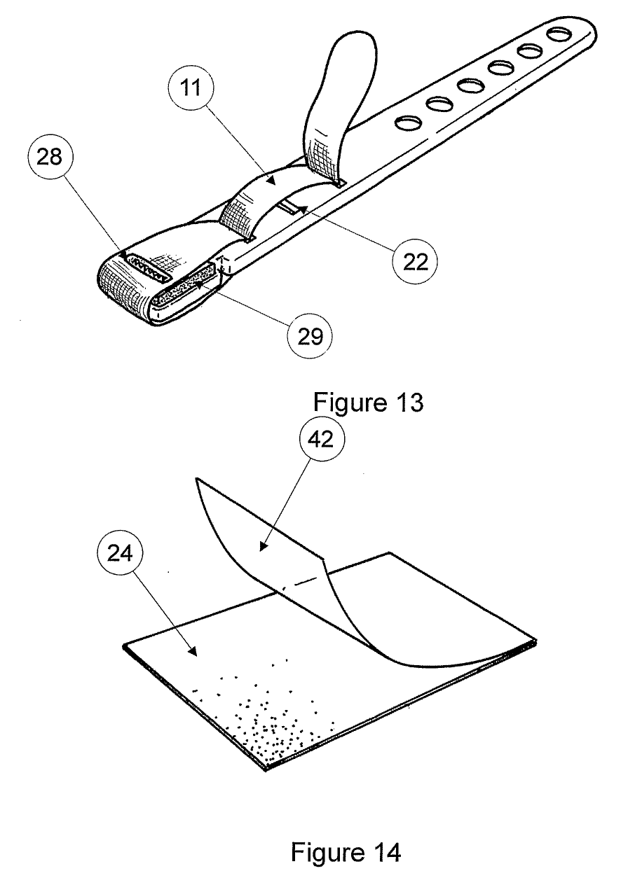

10. External (dry) swab (FIG. 13)
Includes abrasive pads or wettable sponge wipe

11. Adhesive panel (FIG. 14)

For hair or other large dry fragments

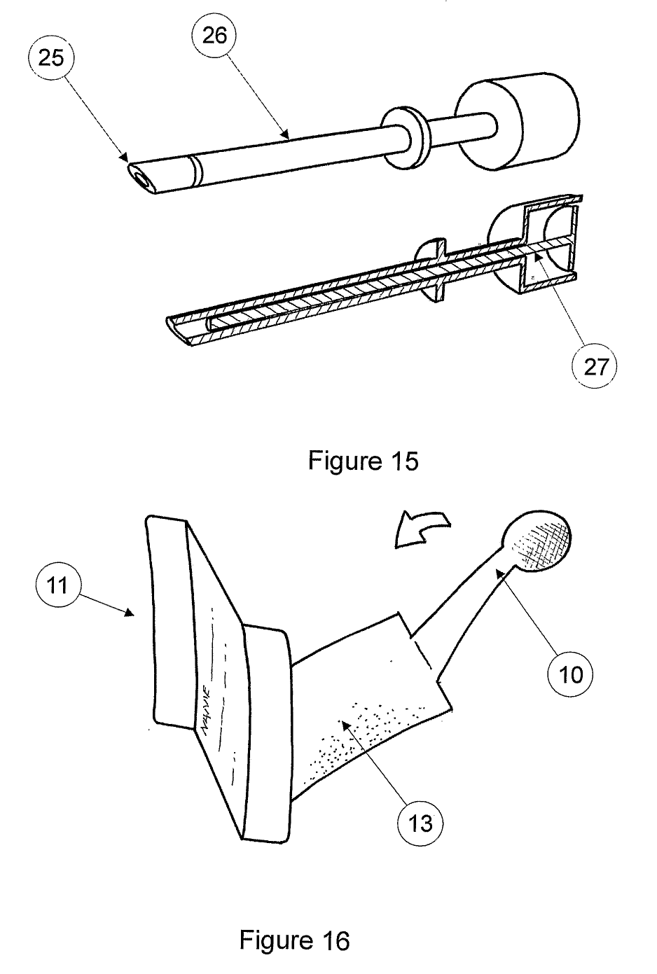

12. Probe (FIG. 15)
For faecal sample or other semi-solid

### Category 1—Blood Sampling Devices:

A lancet device or other skin-penetrating mechanism is required to draw the required blood sample
The drop/s of blood is/are placed in a position marked on an absorbent substrate (12). This sample carrier may be placed within the sample receiver (13) as detailed below.
Sharps selected for this purpose shall be proprietary items, selected for appropriate performance and size to fit the kit.
Any sharps device in a used condition must be stored and disposed of in a regulated manner, that is, stored in an approved sharps container or other protective mechanism and incinerated as medical waste. Thus, the user cannot commonly dispose of the used lancet.
The lancet device may therefore be returned to the laboratory with the return package for correct disposal according to the enclosed instructions.
The kit casing includes provision of a recess or position (14) within the return package for placement of the used sharp
The sharp should be retained by the casing or otherwise removable from the casing for disposal by the laboratory in a safe manner. A recess incorporated in the casing with intruding “fingers” (15) may be sufficient to retain the lancet device.
The kit casing or the sharps device itself shall meet the requirements of standards for the transport of used sharps, by way of puncture resistance and exposure of the sharp. Many devices are commercially available which incorporate integral safety features suitable for this application.

### Category 2—Fluid Sampling Devices:

The most common application of this category is sampling of urine, although a similar device may be adapted for sampling of toilet water (fluid in contact and carrying faecal matter) or other fluid.
Fluid sampling may be undertaken in three ways:
   Direct absorption of fluid onto an absorbent panel
   Gravity-assisted coarse filtration through a membrane
   Pressure assisted filtration through a fine membrane
A direct absorption fluid collector may simply carry an exposed end for plunging into a fluid volume, shaped to suit a particular application and suitably absorbent or textured to retain a minimal sample volume.
A direct absorption collector may be attached to the non-return portion of the kit casing, such that the kit casing itself (being supplied sterile) may be used as a cup (16) to catch a small volume of urine with the user holding the lid portion and allowing the base portion to fill sufficiently to wet the absorbent panel (43) removeably affixed therein.
A gravity assisted fluid collection device usually incorporates a cup element (16) sized to gather a suitable volume of fluid (approximately 20 to 30 mL)
The gravity assisted fluid collector suitably contains a highly absorbent material (17) comprised of either compacted fibres relying on capillary absorption, or other chemical means.
The absorbent material is preferably separated from the collection volume by a hydrophilic membrane (sample carrier) with pore size suitable to act as a coarse filter (10) for the target particles as fluid is drawn through.
The absorbent material is in contact with the membrane and pore size is selected to ensure penetration and drawing-through of the fluid is rapid and consistent.
The surface of the membrane may be textured or otherwise treated to promote adherence of target particles to the membrane.
The filter membrane/sample carrier is typically attached removeably to the collection device housing, such that it may be removed from the housing following absorption of the target fluid, loaded with the collected material.
The collection device may be packaged in a flat form, with fold-out or otherwise expandable members (18), to allow enclosure within the restricted volume of the kit.
The absorbent material may be allowed to expand during its action, and expansion members (19) may be provided in the collector housing to accommodate or control this.
A pressure assisted fluid collection device usually incorporates a vessel of suitable volume (20 to 30 mL) (44), provided with an opening to facilitate urination into the vessel. The opening may preferably be in the form of a cap or end with funnel-shaped aperture (45), affixed to the vessel which is preferably configured to be collapsible from a position of greater volume (filled with fluid) to a position of lesser volume (fluid expelled).
The pressure assisted fluid collection vessel will typically be provided in the collapsed (minimal volume) position such that it occupies minimal kit space.
A secondary cap (46) carrying a filter element (10) is provided to be sealably affixed to the aperture of the vessel, such that fluid may be expelled from the vessel upon compression by finger pressure, via the filter element.
Filter pore size for use in the pressure assisted condition may typically be in the range 0.5 to 5 micron
The vessel and cap/s are preferably shaped or incorporate overhangs or lips (47) to shield the user from contact with fluid and to reduce sample contamination.
The filter element (10) is removeably affixed by way of a thermal weld, mechanical or adhesive bond, such that it will remain in position and leak-free under finger pressure collapsing the collection vessel, but which may be easily peeled away or released by means of an elongate tail portion (11) without risking contamination by contact with other items.
In each collection instance, the sample collection panel or membrane is removed and presented in a substantially flat format suitable for the next step of stabilisation and transport.
   Category 3—Internal (Wet) swab Sampling Devices:
This category includes devices in the form of padded or absorbent-ended swabs. The collectors may be used in any instance where a target material is removed by wiping or absorbing from a surface. This includes buccal cells (inner cheek), vaginal swabs, rectal swabs, external swabs etc.
The sample collection device may incorporate an absorbent substrate (20) enclosed by a removable membrane sample carrier (10), or may incorporate a non-absorbent padded substrate enclosed by the sample carrier. In either case, the target material is drawn into or wiped onto the sample carrier, with the resilient substrate providing sufficient contact to the target surface that the sample collection is maximised.
The action of collecting the target material may be a process of fluid or moisture absorption, leaving material on the membrane surface, as described in the fluid sampler above, or it may be simply sweeping or gently abrading particles from the surface.
Again, the sample carrier material must be sufficiently retentive to the target material to enable maximum collection.
The sample collection device may include a rigid substrate surrounded or covered by the sample carrier, with no padding or absorbent substrate. The device body may be shaped to suit the contours of the collection site.
The sample collection device incorporates an elongated handle (21), to enable control and orientation of the device. The handle may be shaped in any way to improve the ability to hold and control the device in a self-collection scenario.
The sample carrier may be attached removeably to the collection device body by means of adhesive material, mechanical connection or other means. A preferred embodiment incorporates attachment by means of slits in the body of the device (22), into which a small portion of the carrier material is pressed, providing a cheap and effective assembly solution with minimal risk of complication at the point of removal.
The sample carrier incorporates a tail or handling portion (11) as described above, such that the portion of the carrier that must be touched by the user is remote from the sampling area.
For use in cervico-vaginal cell collection, the device may incorporate a larger absorbent mass (23), similar to a tampon, that may be inserted into the vagina for a longer period, such that the increase in size and additional absorption may increase the sample yield from all areas of the vagina. This mass may be sheathed in a removable sample carrier, to reduce transit and laboratory volume.
Alternately, a swab which requires expansion to fill or extend into a cavity may employ mechanical or other means to maximise the sample collection area in contact with the target surface.

### Category 4—External Swab Sampling Devices:

This device category differs from internal (wet) swab devices in that these are adapted to remove dry material from a dry surface.
The sample carrier may be adapted to carry an external surface that is textured, abrasive, adhesive or moistened at the time of application to remove dry material from a surface and capture it on the carrier surface (28).
May incorporate a substrate (29) that is deformable, padded or otherwise conforming to the target surface, to enable maximal sample carrier contact with the surface.
May be used in conjunction with the adhesive panel collection devices described below.

### Category 5—Adhesive Panel/Dry Material Collection Devices:

Incorporates an adhesive panel (24) suitable for the collection of skin cells or free dry material, by placing over the target surface and applying a compressive force.
The adhesive panel may be provided with a repositionable cover (42) to maintain adhesive properties prior to use.
May be used as a location panel for large scale free samples, such as hair strands.
Collection of dry biological material may require the wetting of the sample receiver in order to activate the chemicals which destroy the material. For example, fungal fragments or spores may survive contact with sample receiver chemicals in the dry state, but are unlikely to survive contact with the more active solution if a drop of water is added to the receiver.
May include the ability of the adhesive used in the panel construction to be water soluble, such that the adhesive and the material captured by it may be washed into suspension for concentration and analysis.
May be used in conjunction with or without the sample receiver or treatment action.

### Category 6—Probe Devices:

Incorporation of a sponge, scoop, punch or blade “head” (25) to dislodge and capture particles of larger semisolid samples.
Incorporation of an extended handling body attached to the head
Adaptation of the head to be squeezed retracted or otherwise manipulated to eject the material collected without the need for the user to contact the sample directly. An embodiment may include a punch tube (26) with a mating internal rod (27) slidably engaged within such that forward motion of the inner rod will eject material collected in the tube end by the action of punching the tube into a sample.
The target material may be collected onto a sample carrier sheath or cover, equipped with an elongated handling area as described above for remote removal of the carrier from the collector body and placement within the sample receiver.
The collected material may alternately be deposited directly into the sample receiver.

Following collection of the sample and isolation of the sample carrier, the sample carrier is then preferably treated to render the material benign to enable postal carriage. Postal acceptance rules, particularly in the absence of special-purpose packaging, commonly require the sample to be non-viable and non-infectious. This “stabilisation” may be achieved by physical or chemical destruction or bonding of the sample material or by removal of any medium which may sustain or allow dispersal of biological material. In this way, nucleic acid material may be denatured or cleaved and cellular or other molecular material may be chemically altered and/or the sample may be dried or deprived of a suitable growth media. The degree of denaturing and molecular alteration dictates the nature of remnant material that may be recognised by the subsequent analysis chemistry.

The shorter the remnant nucleic acid fragments, or the more random/severe the chemical alteration, the more specific the test chemistry must be (greater “specificity”), and the less likelihood of a positive match or reaction and successful test.

With the objective of maximising sensitivity and specificity in testing, the amount of molecular alteration or denaturing of the sample should be minimised, thus, the chemical action of the sample receiver must be relatively mild. The sample receiver must also remove moisture from the sample, such that no free fluid is present in the package.

The sample receiver (13) may incorporate two features—desiccation and chemical treatment of the sample. Desiccation may be largely achieved by use of a highly absorbent substrate, such as thick blotting paper. Desiccation may also be assisted by inclusion in the kit of an absorbent material such as silica gel. The chemical treatment may be achieved by addition to, or impregnation of the substrate with a substance activated when in contact with the sample. One embodiment is the addition of a crystalline salt, which may be impregnated into the substrate by wetting in solution followed by drying. When the sample carrier is placed upon the sample receiver, the moist sample dissolves some of the salt, creating an appropriate chemical environment to stabilise the sample. Being crystalline, the salt also assists in dispersal of moisture and desiccation of the sample. A salt which creates a mildly alkaline solution known to disrupt biological molecules, and which is readily available and suitable for impregnation into an absorbent substrate is Sodium Hydroxide (Caustic Soda or NaOH). A gentler and preferred solution is Sodium Chloride (NaCl), with the extent of disruption controlled by the volume of impregnated salt and the subsequent concentration of the solution surrounding the wet sample.

The continued contact with the sample receiver chemicals, particularly when dry, will typically prevent any recombination or sustained viability of the biological material.

The sample receiver is required to completely enclose the sample carrier, and provide maximum contact for the chemical and drying action.

The sample receiver shall be suitably sized to enclose the various sample carriers, and shall remain in a predominantly flat shape when encapsulating the carrier.

The sample receiver may be a folded sleeve of absorbent material, for example blotting paper. The sleeve may simply be a pair of leaves with a single fold (30), or a more complex envelope structure to fully retain the sample carrier. The sample receiver may be separable from the kit casing, or retained by the structure.

Dependent on the type of sample associated with the kit, the sample receiver or other element of the return package may include a deodorizing agent to mask or remove any odour that may emanate from the sample.

The sample receiver construction may incorporate an impermeable layer such that the impregnated chemical may not come into direct contact with the user during alignment and placement of the sample carrier within.

The sample receiver may also be configured to reduce the handling required to enclose the sample carrier. The sample receiver may include a folded corner (31) or other shaped section to allow easy opening of the folded sleeve. The sleeve may be automatically opened by the opening of the kit casing, such that the receiving surface is presented immediately, with no handling required.

The sample carrier may be placed within the receiver in any orientation, however, in order to maximise the treatment action, the carrier may be placed such that it is substantially spread flat onto the receiver surface. It is not intended that the carrier is handled to maintain this shape, but a printed outline (32) indicating position or orientation may be placed on the receiver surface to act as a guide to the user.

To achieve a spread position, the sample carrier membrane (which may be inherently prone to crumpling) may be reinforced at its perimeter (33) or other areas to maintain a substantially flat or extended structure when removed from the collection device body.

To further reduce the risk of contamination, the sample receiver may be marked with alignment marks indicating the position of the sample carrier with the elongated tail or handling portion external to the receiver sleeve (34).

Depending on the nature of the sample (eg a hair sample), the chemical treatment of the material may not be required, or may be very mild. For particularly robust samples, treatment may be customised at a more aggressive level. The chemical action may be modified by concentration or composition to achieve the desired level of sample stabilisation.

Certain kits not requiring sample treatment may exclude the impregnated sample receiver in favour of a non-impregnated sleeve. In the interests of production rationalization, it is likely that all kits will retain the full complement of components, but with variants of materials or chemical applications.

Upon closure of the casing, the sample receiver sleeve is slightly compressed by the walls of the casing, thus retaining the sample carrier and ensuring maximum contact of the sample carrier to the receiver chemicals.

The material of the sample receiver is selected such that minimal target sample material is removed from the sample carrier upon removal of the sample carrier at the laboratory. The sample carrier is removed from the receiver either by simply tipping out, or removing with tweezers.

The user is required to identify themselves and provide a signature which indicates agreement to the terms and conditions of the testing process (provide with the kit, or in external literature); authority to use the sample provided; and verification that the sample is indeed provided by them according to the instructions provided. This signature may be applied to a writable panel (35) affixed to the kit. The signature panel must be affixed permanently to the returnable portion (36) of the kit and may be incorporated into the tamper-evident return seal (37), whereby the application of the seal is also verified by the signature.

The signature may be accompanied by a date, from which the natural degradation of the specimen over time may be judged.

The return seal may comprise a self-adhesive label, which, with the backing layer (38) removed, may be affixed over the casing closure and permanently adhered to the opposing side. The label adhesion may be sufficiently strong to destroy the label on attempted opening, or the label may incorporate weakened or perforated sections to enable rapid verification of casing integrity. The correct positioning of the label may be indicated on the casing, such that incomplete closure may be rectified by the user prior to attachment.

For the purposes of verifying the identity of the user when collecting test results, a unique identifier matched to the kit may be retained by the user. This identifier may be printed on the rear backing layer of the adhesive tamper label or another removable portion of the labelling. Should results be collected by phone or online, the user may quote this identifier to verify their identity.

The user signature label may be positioned to enable scanning, complete removal or other recording of the application of the signature by the laboratory, as this label constitutes a legal document and record of chain of custody.

To reduce the volume of material returned to the laboratory, the kit casing may be divided into two segments which are designated for enclosure of the sample, and for the collection devices. The segment of the kit casing which contained the collection device may be attached to the other by means of a thin neck (39) or other means, such that it may be broken away or otherwise removed for return of the sample. The integrity of the perimeter seal must not be affected by this break portion.

The removed portion of the casing may be used to enclose the used collection device, for discrete disposal by the user.

The return package must provide the same level of protection to the contents as the primary package.

Opening of the casing at the laboratory shall be fast and safe, in terms of operator health and contamination/damage to the sample. The tamper evident labels or mechanisms must allow for rapid assessment of integrity, followed by simple removal or deactivation for kit opening. The position of tamper-evident elements and the shaping of the casing should enable safe opening of the casing by lab staff, by for example, providing a guide slot (40) in which to run a sharp knife to slit the seal label.

For identification of the sample through the laboratory analysis, a series of pre-prepared identification labels (41) or markers may be incorporated into the kit, such that as the sample is removed from the carrier, the receptacles or testing vials may be provided with matching labels taken directly from the test kit, thus avoiding mix-ups. The tamper seal may incorporate a suitable number of removable labels incorporating barcodes or other identifiers readable by the laboratory. The number of labels provided will match the common process of laboratory test steps.

An alternative method of sample identification may be the use of single or multiple RFID chips, placed on the sample carrier or other component of the kit. Due to the small size and robustness of these chips, and their unique identification characteristics, the chip may be suitably protected and incorporated into the volume of test fluid and, as such, follow the sample to the conclusion of the test without the need for further labelling.

An advantage of the use of RFID identity tags is that the database of test progress and completion does not include a human-error risk of mislabeling or incorrect entry, and the manual processes included in the testing are reduced.

In a second form, wherein individual transport and thus the robust casing of the kit is not required, such as may be the case when in use at a collection centre or supervised collections, the sample collection device may incorporate elements of the sample carrier, receiver and labelling requirements into one component.

In this instance, the collection devices, including, for example, the swab sticks or the collapsible urine vessels are provided to the user without the kit, and the sample carriers, when collections are complete, are transported to the laboratory in bulk.

The sample carrier (10) may allow for additional space on the handling “tail” portion (11) of the carrier to enable recording of user identification, plus a fold-over or other enclosing portion (sample receiver) (13) into which the sample collection end of the carrier may be placed.

In this way, the bulk and waste materials associated with testing of a number of users is reduced, and patient details securely accompany the sample to a testing facility.

The sample receiver portion of the integrated carrier may require non-absorbent backing or a similar barrier to handling, or may carry a removable cover to maintain cleanliness until the sample carrier portion is ready to be received. In this instance, the enclosure of the sample carrier may be undertaken by a practitioner rather than by the user themselves.

In all cases, the sample carrier is designed at minimal size such that separation of the target material in the laboratory uses minimal fluid volume. The sample carrier is placed in a container of fluid suitable to remove biological material from the substrate and agitated to assist removal. The smallest possible sample carrier requires a smaller fluid volume and thus less wastage and cost for the laboratory.

In the present specification and claims (if any), the word “comprising” and its derivatives including “comprises” and “comprise” include each of the stated integers but does not exclude the inclusion of one or more further integers.

Reference throughout this specification to “one embodiment” or “an embodiment” means that a particular feature, structure, or characteristic described in connection with the embodiment is included in at least one embodiment of the present invention. Thus, the appearance of the phrases “in one embodiment” or “in an embodiment” in various places throughout this specification are not necessarily all referring to the same embodiment. Furthermore, the particular features, structures, or characteristics may be combined in any suitable manner in one or more combinations.

1. A device for the collection and transport of biological material, the device including a container having at least two parts temporarily attached together and adapted for storage of biological collection indicia on an outbound leg of the transport and the safe transport of a biological sample on an inbound leg wherein the biological sample is rendered benign during transport and transported in one of the container parts.

2. A device according to claim 1 including a kit of manufactured items comprising all components sent to users, including envelopes or similar, a primary package two part container that the collection device arrives in and includes a return package to be returned to the laboratory, at least one collection device used to physically collect the sample, a sample carrier portion of the at least one collection device to which the target biological material is collected or concentrated and a sample receiver component within the return package into which the sample carrier is placed.

3. A device according to claim 1 wherein the container casing includes top and bottom halves and a sealing means for releasably opening and resealing the container.

4. A device according to claim 3 wherein the sealing means includes a perimeter seal fin and trench provided with finger tabs placed to allow easy opening of the casing.

5. A device according to claim 3 wherein the casing is provided with at least one, one-way type openings to allow pressure and moisture balancing and further avoid inadvertent opening.

6. A device according to claim 1 further including a tamper-evident mechanism, to assure the integrity of the contents as they arrive at the user.

7. A device according to claim 2 wherein the kit contains instructions, at least one sample collection device, at least one sample enclosure and treatment component, at least one waste collection and disposal element, and return seal and user/kit identification.

8. A device according to claim 7 wherein the instructions are displayed on a panel attached to the top half of the casing, such that the to half of the casing remains in an open position and the user is minimally required to turn pages or otherwise handle kit materials.

9. A device according to claim 2 wherein the sample carrier includes a removable portion of minimal size which carries the target material, for return to the laboratory.

10. A device according to claim 2 wherein the sample carrier is associated with the collection device and is removable from the collection device by means of a handling portion configured such that the user is not subject to contact with the sample area itself.

11. A device according to claim 2 wherein the sample carrier carries the target material in a manner that the target material is releasable into fluid upon immersion and agitation of the sample carrier.

12. A device according to claim 2 wherein after collection of the target material, the sample carrier is treated or stabilised to render the material benign to enable postal carriage.

13. A device according to claim 12 wherein stabilisation is achieved by physical or chemical destruction or bonding of the sample material or by removal of any medium which may sustain or allow dispersal of biological material.

14. A device according to claim 2 wherein the sample receiver includes two functions, namely desiccation and chemical treatment of the target material.

15. A device according to claim 2 wherein upon closure of the casing, the sample receiver is slightly compressed by the walls of the casing, to retain the sample carrier and maximise contact of the sample carrier with the sample receiver.

16. A device according to claim 3 wherein the containers of the device are attached to one another by a frangible portion until the user forcibly separates the containers from one another.

17. A device according to claim 1 wherein at least one Radio Frequency Identification (RFID) devices are placed on the sample carrier to identify and track the sample.

18. A device according to claim 2 wherein the collection device is a blood sampling device including a skin-penetrating mechanism, and the sample carrier includes an absorbent substrate.

19. A device according to claim 2 wherein the collection device is a fluid sampling device including a collection device adapted to having an exposed end for plunging into a fluid volume, and absorbent or textured to retain a minimal sample volume, and the sample carrier includes a hydrophilic membrane with a pore size suitable to act as a coarse filter for the target particles as fluid is drawn through, the hydrophilic membrane attached removeably to the collection device housing, such that it may be removed from the housing following absorption of the target fluid, loaded with the collected material.

20. A device according to claim 2 wherein the collection device is an internal swab sampling device with padded or absorbent-ended swabs attached removeably to the collection device.

21. A device according to claim 2 wherein the collection device is an external swab sampling device are adapted to remove dry material from a dry surface and capture it on the carrier surface.

22. A device according to claim 2 wherein the collection device is an adhesive panel suitable for the collection of skin cells or free dry material by placing the panel over the target surface and applying a compressive force or by simply placing the target material onto the adhesive panel with a repositionable cover to maintain adhesive properties prior to use.

23. A device according to claim 2 wherein the collection device includes a probe device having a head portion to dislodge and capture particles of larger semi-solid samples and an extended handling body attached to the head portion.

24. A device according to claim 23 wherein the probe device includes a punch tube with a mating internal rod slidably engaged within such that forward motion of the inner rod will eject material collected in the tube end by the action of punching the tube into a sample.

25. A sample collection device including a sample carrier portion for collection or concentration of target biological material and a sample receiver component into which the sample carrier is placed for transport of the target biological material to a laboratory.
